(19) United States
(12) Patent Application Publication
(10) Pub. No.: US 2025/0152976 A1
(43) Pub. Date: May 15, 2025

(54) ROPE ACTUATING DEVICE

(71) Applicant: Harken, Incorporated, Pewaukee, WI (US)

(72) Inventors: Jonathan D. Malcolm, Wales, WI (US); Kirk M. Mauthner, Wilmer (CA)

(73) Assignee: Harken, Incorporated, Pewaukee, WI (US)

(21) Appl. No.: 18/942,126

(22) Filed: Nov. 8, 2024

Related U.S. Application Data
(60) Provisional application No. 63/598,266, filed on Nov. 13, 2023.

(51) Int. Cl. A62B 1/14

(52) U.S. Cl. CPC A62B 1/14

(57) ABSTRACT

A rope actuating device is provided having a chassis with a rear wall and a fixed brake with a first rope engagement surface being coupled with or extending from the chassis, along with a sheave having a central groove extending between a first sidewall and a second sidewall, wherein at least one of the first sidewall and the second sidewall include teeth, and the central groove is engageable with a rope, with the sheave rotatably coupled at least indirectly with the chassis. Further including a pawl assembly having a swing arm rotatably coupled with the chassis, and a pawl at least indirectly coupled with the swing arm, wherein the pawl includes a second rope engagement surface and a pawl catch for engagement with one or more of the teeth, and a lever assembly rotatably coupled to the chassis and at least indirectly coupled to the swing arm and pawl assembly.

### CROSS-REFERENCE TO RELATED APPLICATION

This application claims priority to U.S. Provisional Patent Appl. No. 63/598,266 filed on Nov. 13, 2023. The disclosure of which is incorporated herein by reference.

### FIELD OF THE INVENTION

The described embodiments relate generally to the field of rope-based activities. More particularly, the embodiments relate to descent and ascent control devices used to manage loads suspended by ropes.

### BACKGROUND OF THE INVENTION

Descenders are widely used in the field of rope access and rescue for controlling the descent of people or equipment suspended by rope. Descenders are commonly used by operators to descend down a rope that is affixed overhead. Descenders may also be attached to an anchor position to allow an operator to control the descent of one or more people or gear from a remote location. Typically, descenders are comprised of elements that clamp or pinch the rope and are self-energized by load applied to the rope in one direction through the device. Controlled release is typically achieved by actuation of a lever which alleviates the clamping force holding the rope, allowing controlled release of rope through the device. Under certain circumstances it is necessary to raise or haul a load by pulling rope through the descender, thereby reversing the direction of travel. In these cases, the descender serves as a turning point for the rope and a means of progress capture.

Conventional descenders employ a cam capable of limited rotation wherein contact with the tensioned rope wrapped around a portion of the cam urges the cam rotationally, thereby clamping the rope between the cam and a fixed braking surface. Such cam based descenders require relatively few moving parts, allowing them to be compact, lightweight, and inexpensive, but when acting as a turning point, the loaded rope must slide over the cam, greatly reducing efficiency thereby increasing effort for the operator. More recently some descenders have employed a one-way rotating sheave that allows the descender to become an efficient turning point for advancing the descender along the loaded rope. These devices tend to be undesirably large and heavy and are considerably more expensive than a more basic descender due to the added complexity of their rotationally backstopping hub. As such, there is a need for a lightweight, compact, and affordable descender capable of acting as an efficient turning point.

It will be understood by those skilled in the art that one or more aspects of this invention can meet certain objectives, while one or more other aspects can lead to certain other objectives. Other objects, features, benefits and advantages of the invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF SUMMARY

In at least some embodiments, disclosed is a rope actuating device that includes a chassis with a chassis rear wall; a fixed brake coupled with or extending from the chassis, the fixed brake including a first rope engagement surface; a sheave having a central groove extending between a first sidewall and a second sidewall, wherein at least one of the first sidewall and the second sidewall include teeth, wherein the central groove is engageable with a rope, and the sheave is rotatably coupled at least indirectly with the chassis; a pawl assembly including a swing arm rotatably coupled with the chassis; and a pawl at least indirectly coupled with the swing arm, wherein the pawl includes a second rope engagement surface and a pawl catch for engagement with one or more of the teeth; and a lever assembly rotatably coupled to the chassis and at least indirectly coupled to the swing arm and the pawl assembly, wherein actuation of the lever assembly provides selectable rotational movement of the swing arm and the pawl assembly.

Other embodiments, aspects, features, objectives and advantages of the invention will be understood and appreciated upon a full reading of the detailed description and the claims that follow.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. Like reference numerals may be used to indicate like components. In the drawings:

FIG. 1 is a front perspective view of an exemplary embodiment of a rope actuating device;

FIG. 2 is a rear perspective view of the rope actuating device of FIG. 1;

FIG. 3 is a front perspective view of the rope actuating device of FIG. 1 shown with a chassis cover plate rotated open;

FIG. 4 is a front perspective view of the rope actuating device of FIG. 3 shown with an engaged rope;

FIG. 5 is an exploded front perspective view of the rope actuating device of FIG. 1;

FIG. 6 is an exploded rear perspective view of the rope actuating device of FIG. 1;

FIG. 7 is a front perspective view of the chassis of the rope actuating device of FIG. 1;

FIG. 8 is a front perspective exploded view of the pawl assembly of the rope actuating device of FIG. 1;

FIG. 9 is a rear perspective exploded view of the pawl assembly of the rope actuating device of FIG. 1;

FIG. 10 is a front view of the sheave of the rope actuating device of FIG. 1;

FIG. 11 is a front perspective view of the sheave of FIG. 10;

FIG. 12 is a side view of the sheave of FIG. 10;

FIG. 13 is a perspective view of the lever assembly from the rope actuating device of FIG. 1;

FIG. 14 is an exploded perspective view of the lever assembly of FIG. 13;

FIG. 15 is a rear perspective view of the rope actuating device of FIG. 1 shown with the release handle and handle cover plate omitted for illustrative purposes;

FIG. 16 is a front view of the rope actuating device of FIG. 1 shown with a rope in a hoisting position and the chassis cover plate removed for illustrative purposes;

FIG. 17 is a front view of the rope actuating device of FIG. 1 shown with a rope in a clamped position and the chassis cover plate removed for illustrative purposes;

FIG. 18 is a front view of a second exemplary embodiment of the rope actuating device with the chassis cover plate rotated open;

FIG. 19 is a perspective front view of the rope actuating device of FIG. 18;

FIG. 20 is a perspective rear view of the rope actuating device of FIG. 18;

FIG. 21 is an exploded front perspective view of the rope actuating device of FIG. 18;

FIG. 22 is an exploded rear perspective view of the rope actuating device of FIG. 18;

FIG. 23 is perspective front view of the rope actuating device of FIG. 18 with the sheave removed for illustrative purposes;

FIG. 24 is perspective front view of the rope actuating device of FIG. 18 with the sheave and pawl assembly removed for illustrative purposes;

FIG. 25 is perspective front view of the chassis of the rope actuating device of FIG. 18;

FIG. 26 is perspective rear view of the chassis of the rope actuating device of FIG. 18;

FIG. 27 is a first exploded perspective view of the pawl assembly of FIG. 18;

FIG. 28 is a second exploded perspective view of the pawl assembly of FIG. 18;

FIG. 29 is third exploded perspective view of the pawl assembly of FIG. 18;

FIG. 30 is a perspective view of the release handle of the lever assembly of FIG. 18 showing a roller in abutment therewith;

FIG. 31 is a front view of the rope actuating device of FIG. 18 with a rope secured therethrough and the chassis cover plate open;

FIG. 32 is a front perspective view of a third exemplary embodiment of the rope actuating device;

FIG. 33 is a rear perspective view of the rope actuating device of FIG. 32;

FIG. 34 is a front view of the rope actuating device of FIG. 32 shown with an engaged rope;

FIG. 35 is a front perspective view of the rope actuating device of FIG. 32 shown with an engaged rope and a chassis cover plate rotated open;

FIG. 36 is a front perspective view of the rope actuating device of FIG. 32 shown with the chassis cover plate removed;

FIG. 37 is a front view of the rope actuating device of FIG. 32 shown with the chassis cover plate removed;

FIG. 38 is an exploded front perspective view of the rope actuating device of FIG. 32;

FIG. 39 is an exploded rear perspective view of the rope actuating device of FIG. 32;

FIG. 40 is a front perspective view of the pawl assembly of the rope actuating device of FIG. 32;

FIG. 41 is a rear perspective view of the pawl assembly of the rope actuating device of FIG. 32;

FIG. 42 is a rear perspective exploded view of the pawl assembly of the rope actuating device of FIG. 32;

FIG. 43 is a bottom perspective exploded view of the pawl assembly of the rope actuating device of FIG. 32;

FIG. 44 is a perspective view of the chassis of the rope actuating device of FIG. 32;

FIG. 45 is a perspective view of the chassis cover fastener of the rope actuating device of FIG. 32;

FIG. 46 is a front perspective view of the sheave support of the rope actuating device of FIG. 32;

FIG. 47 is a rear perspective view of the sheave support of the rope actuating device of FIG. 32;

FIG. 48 is an exploded rear perspective view of the lever assembly of FIG. 32;

FIG. 49 is an exploded front perspective view of the lever assembly of FIG. 32;

FIG. 50 is a rear view of the rope actuating device of FIG. 32 shown with the handle cover plate, lever spring, and release handle removed for illustrative purposes;

FIG. 51 is a front view of the rope actuating device of FIG. 32 shown with the lever assembly fully actuated to unclamp (release) the rope, with the chassis cover plate removed for illustrative purposes;

FIG. 52 is a perspective view of another embodiment of the sheave;

FIG. 53 is another perspective view of the sheave of FIG. 52; and

FIG. 54 is a front view of the sheave of FIG. 52.

### DETAILED DESCRIPTION

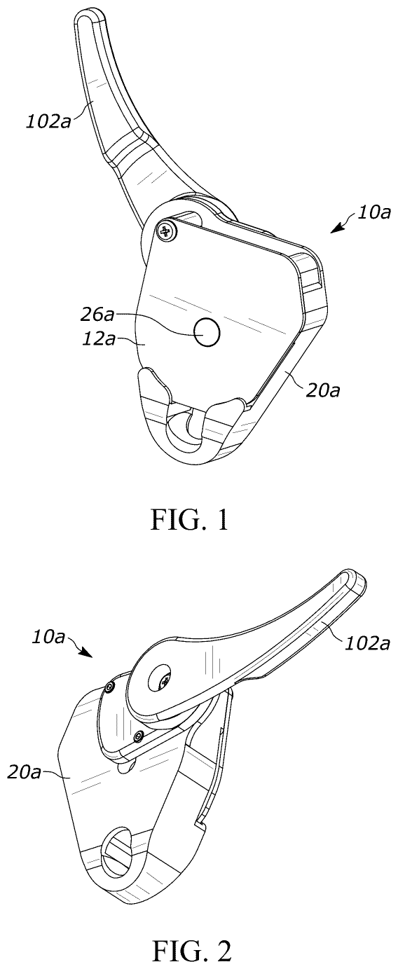

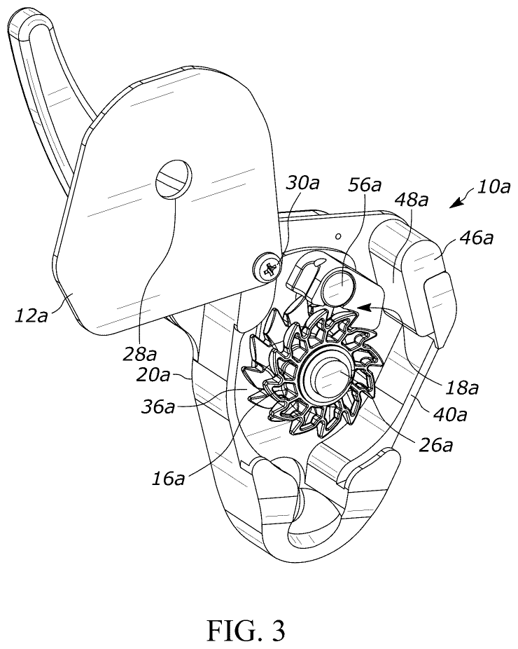

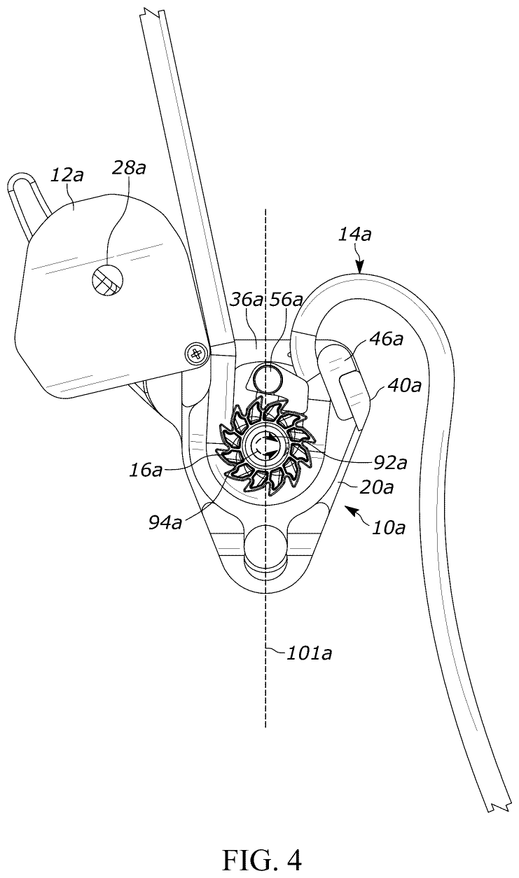

Referring to FIGS. 1-3, front and rear perspective views of a first exemplary embodiment of a rope actuating device 10a are provided. FIG. 3 shows the rope actuating device 10a with a chassis cover plate 12a rotated to an open position to allow a rope 14a to be inserted and engaged with a sheave 16a and a pawl assembly 18a that are coupled with a chassis 20a. A sheave washer 19a can be provided in front of the sheave 16a. FIG. 4 shows the rope 14a engaged with the rope actuating device 10a in a typical use configuration. The rope actuating device 10a is configured to be coupled to a person or object and be releasably engaged with the rope 14a to allow the rope actuating device 10a to ascend or descend along the length of the rope 14a. A variety of enclosing, opening, and latching mechanisms may be employed to allow a user to rig the rope actuating device 10a. In at least some embodiments, the rope 14a can be inserted by opening the chassis cover plate 12a, which in at least some embodiments is accomplished by actuating a chassis cover fastener 26a. In at least some embodiments the chassis cover fastener 26a is centrally mounted button that is outwardly biased and depressible to disengage from a cover aperture 28a in the chassis cover plate 12a, thereby allowing the chassis cover plate 12a to rotate sideways about a fastener 30a to allow insertion or removal of the rope 14a, although other mechanisms may be used as well, such as a rotating fastener, etc.

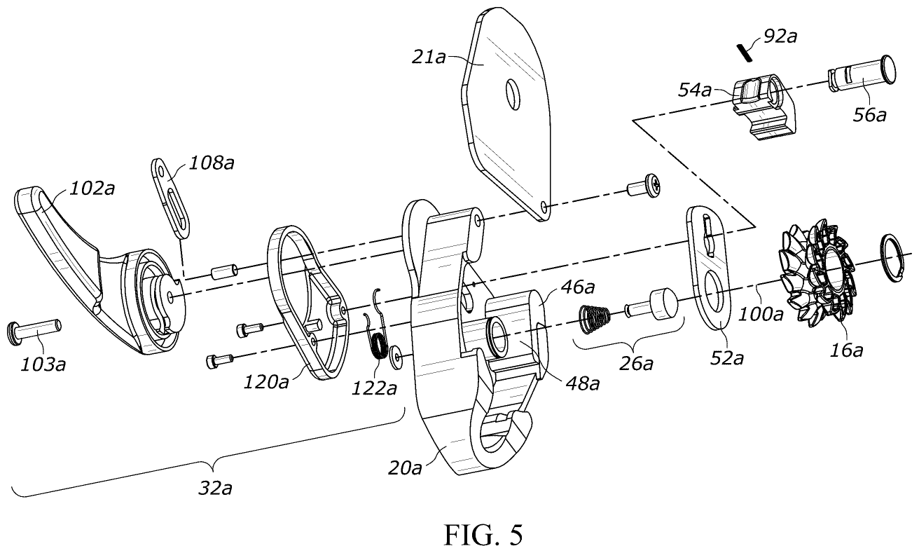

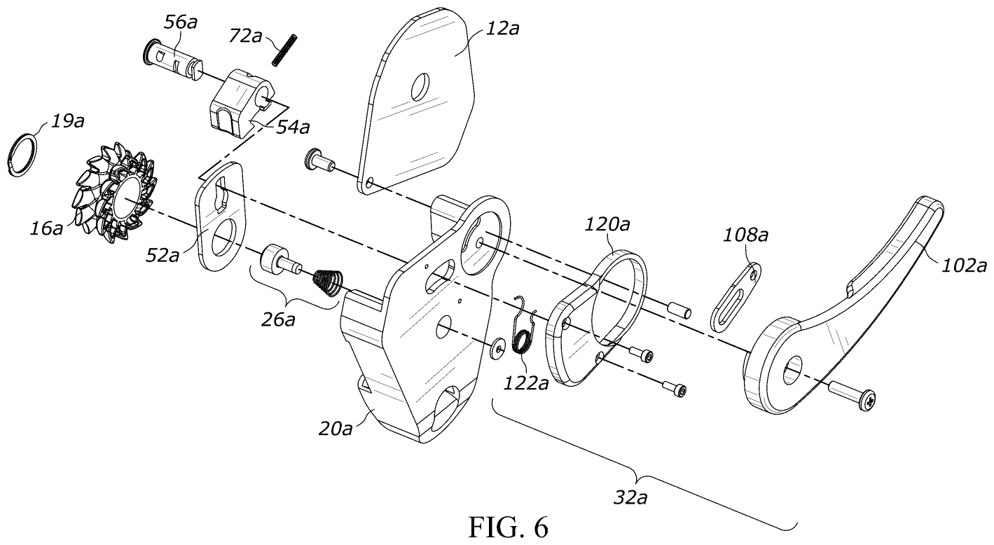

The rope actuating device 10a further includes a lever assembly 32a that is coupled with the pawl assembly 18a, which can be actuated to release tension applied to the rope 14a by the pawl assembly 18a, such as when the rope actuating device 10a is in use and under load. Referring to FIGS. 5 and 6, exploded front and rear perspective views of the rope actuating device 10a are provided showing various exemplary components, including the sheave 16a, pawl assembly 18a and lever assembly 32a, along with various fasteners.

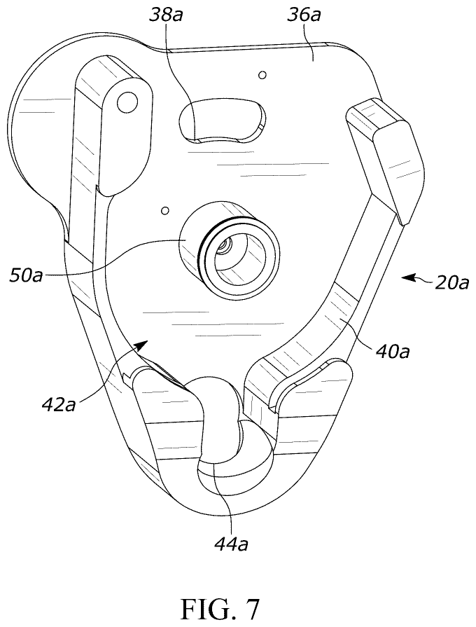

Referring to FIG. 7, the chassis 20a includes a rear wall 36a having a release slot 38a formed therein, where in at least some embodiments, the rear wall 36a is generally planar and the release slot 38a is arced. A sidewall portion 40a extends substantially perpendicularly from the rear wall 36a and along with the chassis cover plate 12a, forms an inner cavity 42a. In at least some embodiments, the sidewall portion 40a is generally U-shaped or V-shaped, although other configurations can be utilized to house the rope. The rope actuating device 10a includes a load attachment portion 44a, which in at least some embodiments, is positioned about the bottom of the chassis 20a, and can include an aperture that extends through the rear wall 36a. The load attachment portion 44a is configured to engage a carabiner or other suitable latching component to couple the rope actuating device 10a to a user or other type of load. In at least some embodiments, the load attachment portion 44a can alternatively include a bar or pin for attachment purposes.

The chassis 20a further includes a fixed brake 46a, which can be integrally formed, such as with the sidewall portion 40a, while in other embodiments it can be removably coupled to the sidewall portion 40a or another portion of the chassis 20a. The fixed brake 46a can take many forms capable of providing a first rope engagement surface 48a for engaging the rope 14a, although in at least some embodiments, it can be generally P-shaped with the first rope engagement surface 48a being generally planar (see FIG. 3), while in other embodiments, it can take other shapes and the first rope engagement surface 48a can be grooved. Further, as seen in FIG. 7, the chassis 20a can include a cylindrical sheave support 50a, which in at least some embodiments, extends perpendicularly from the rear wall 36a.

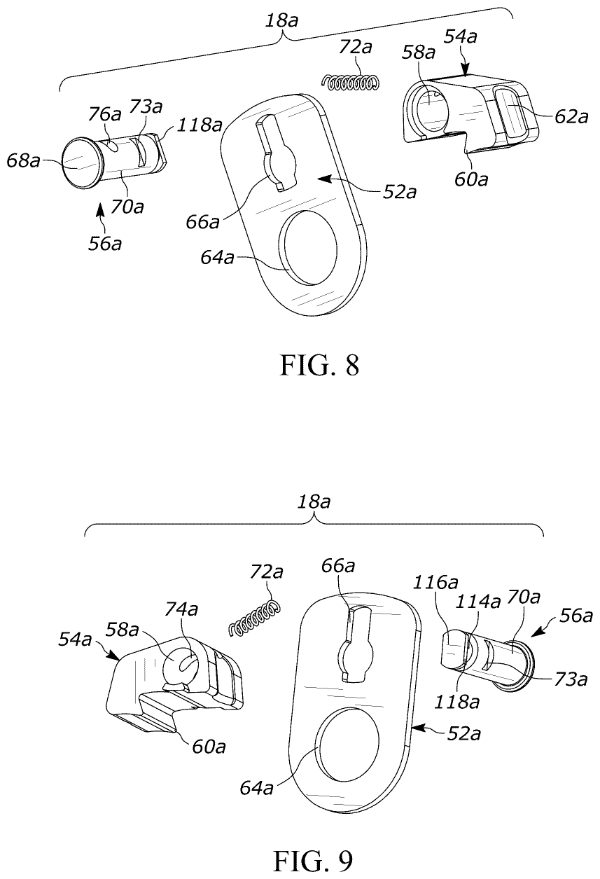

Referring now to FIGS. 8 and 9 showing the pawl assembly 18a in exploded perspective views, the pawl assembly 18a includes a swing arm 52a, a pawl 54a, and a pawl hinge rod 56a. In at least some embodiments, the pawl 54a includes a pawl pivot aperture 58a extending perpendicularly therethrough, a pawl catch 60a, and a second rope engagement surface 62a. The pawl 54a is coupled with the swing arm 52a by the pawl hinge rod 56a. The swing arm 52a is configured to rotate about the sheave support 50a, wherein in at least some embodiments, the swing arm 52a includes a circular aperture 64a sized to allow the sheave support 50a to slide over. The swing arm 52a further includes a plate slot 66a. The pawl hinge rod 56a includes a pin head 68a and a pin shaft 70a, wherein during assembly, the pin shaft 70a extends first through the pawl pivot aperture 58a, then the plate slot 66a, and is then coupled to the lever assembly 32a as discussed below. In at least some embodiments, the pawl 54a is biased in a clockwise/downward direction, wherein the biasing can be accomplished in various ways, such as with a pawl spring 72a inserted into a spring passage 74a in the pawl 54a, where the pawl spring 72a is in abutment with a spring notch 76a in the upper portion of the pawl hinge rod 56a. The pin shaft 70a can also include a pair of opposed slots 73a sized to engage a narrower upper portion of the plate slot 66a.

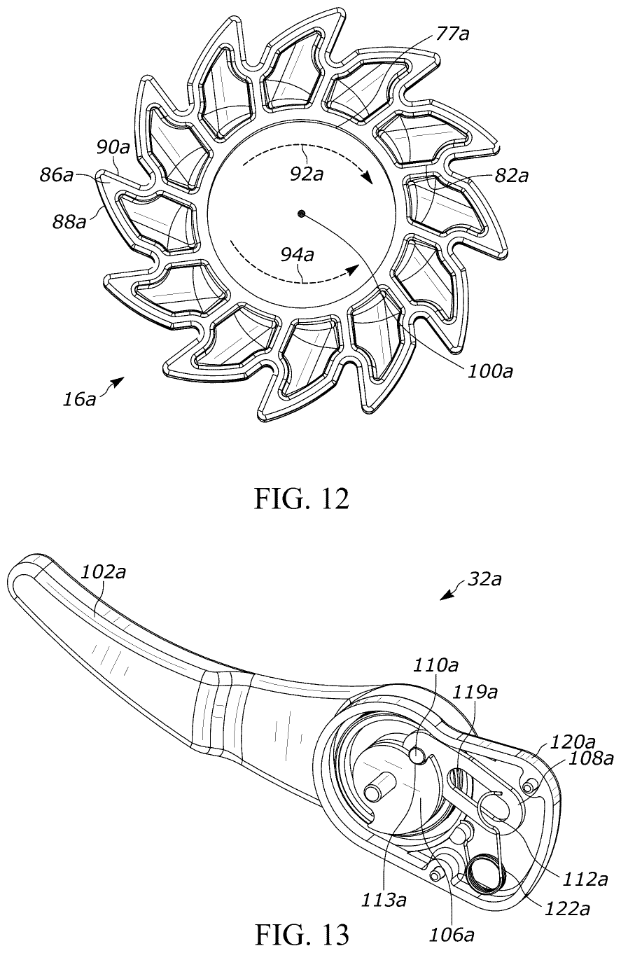

The sheave 16a provides a rotatable support for feeding the rope 14a through the rope actuating device 10a, wherein the sheave 16a can be rotatably coupled to the chassis 20a in various ways and rotates about a sheave central axis 100a (see FIG. 12). In at least some embodiments, to facilitate rotational coupling, the sheave 16a can include a central sheave aperture 77a configured for rotational coupling to the chassis 20a (or swing arm 52a as discussed below). In some embodiments, the sheave aperture 77a can include a bearing assembly to facilitate easy rotation.

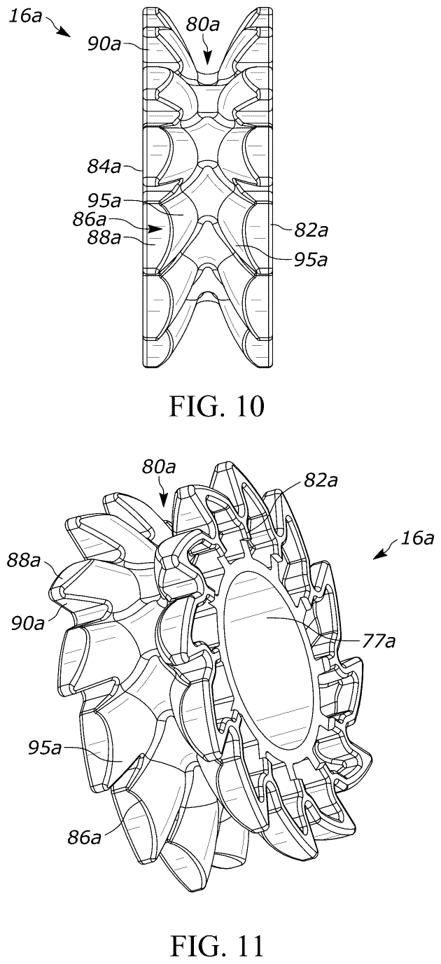

The sheave 16a can take many forms, although in at least some embodiments, such as show in FIGS. 10-12, the sheave 16a includes a central groove 80a that extends between a first sidewall 82a and a second sidewall 84a, wherein the central groove is engageable with the rope 14a and in at least some embodiments is tapered, angled, and/or textured to better grip the rope 14a. In the first exemplary embodiment shown in FIGS. 10-12, the first sidewall 82a and second sidewall 84a each include generally saw-shaped teeth 86a having a top edge 88a and a rear edge 90a, although in other embodiments, the teeth 86a can be provided on only one of the first sidewall 82a and second sidewall 84a. The teeth 86a are configured so the rear edge 90a is caught/engaged by the pawl catch 60a to prevent rotation of the sheave 16a in a first rotational direction 92a (clockwise), yet still allow the top edge 88a to abut and displace the pawl catch 60a as needed to allow rotation of the sheave 16a in a (opposite) second rotational direction 94a (counter-clockwise). As such, in at least some embodiments, the top edge 88a has a radial slope, while the rear edge 90a is radially straight, as seen in FIGS. 10-12. In addition, in some embodiments, such as shown in FIGS. 10-12, the teeth 86a can each have a convex inner sidewall 95a. In at least some embodiments, the convex inner sidewalls 95a extend inward. Further, the teeth 86a can widen as they extend radially from the top edge 88a towards the central sheave aperture 77a to provide a general V-shape to the central groove 80a extending to the top edge 88a.

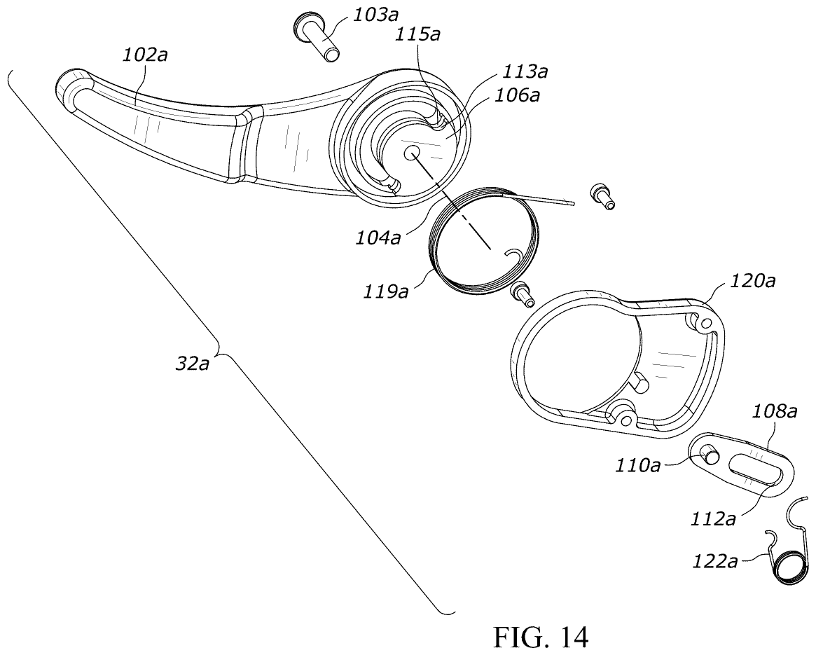

Referring now to FIGS. 13 and 14, provided are assembled and exploded views of the lever assembly 32a. The lever assembly 32a includes a release handle 102a that is coupled with the pawl and provides a user controlled release mechanism for the rope 14a. A variety of mechanical arrangements may be employed to link movement of the release handle 102a to the pawl assembly 18a to release the rope 14a, and as such, the rope actuating device 10a shall not be limited by a specific coupling mechanism therebetween. In at least some embodiments, the release handle 102a is rotationally coupled with the chassis 20a by a handle fastener 103a extending along a handle pivot axis 104a and further includes an engagement portion 106a coupled with a bar link 108a. In at least some embodiments the bar link 108a includes a bar pin 110a extending perpendicularly therethrough and a bar slot 112a extending longitudinally therealong. The bar pin 110a is coupled with the engagement portion 106a, which in at least some embodiments includes a radial slot configuration with a curved catch wall 113a that cups and pulls the bar pin 110a during rotation of the release handle 102a, allowing the bar link 108a to partially enter a cam slot 115a for clearance, and cause longitudinal movement of the bar link 108a. The bar slot 112a is sized and shaped to couple with the pawl hinge rod 56a, wherein in at least some embodiments the end of the pawl hinge rod 56a includes a circular bar slot groove 114a and an end plate 116a. The bar slot groove 114a is sized to slidably fit inside the bar slot 112a, and the end plate 116a can include a generally circular shape but with a pair of chamfered (i.e., straight) opposing side portions 118a, such that the end plate 116a can be fittingly inserted through the bar slot 112a and then rotated ninety degrees to provide an interlock. The chassis 20a can include a pin slot to guide the bar pin 110a. Although the bar link 108a is shown having an exemplary bar-shape, it shall not be limited to that form, as it can take other forms and maintain the desired functionality, for example the bar slot 112a can include a rod with a slot formed therein, or other coupling portions capable of coupling the release handle 102a with the pawl assembly 18a. A handle cover plate 120a can also be provided to enclose and guide the bar link 108a along with a lever spring 119a coupled between the handle and the handle cover plate 120a to bias the release handle 102a upwards.

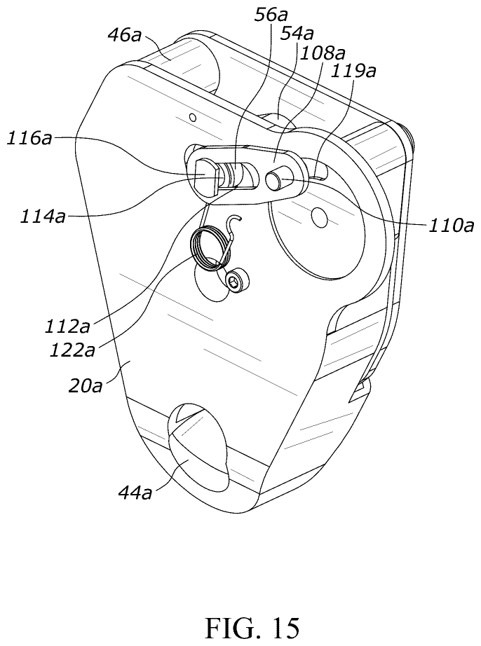

Referring to FIG. 15, a rear perspective view of the rope actuating device 10a is provided with the release handle 102a and handle cover plate 120a omitted to best illustrate the interconnection of the bar link 108a, and the pawl hinge rod 56a. In at least some embodiments, the pawl assembly 18a is biased toward the fixed brake 46a, one such biasing method can include a bias spring 122a, which engages with the pawl hinge rod 56a and a post on the inside of the handle cover plate 120a, although other biasing configurations can be utilized. In at least some embodiments, a handle return spring can be provided to bias the handle in a more vertical stowed position relative to the chassis 20a when not in use, to reduce the chance of inadvertent rotation/activation.

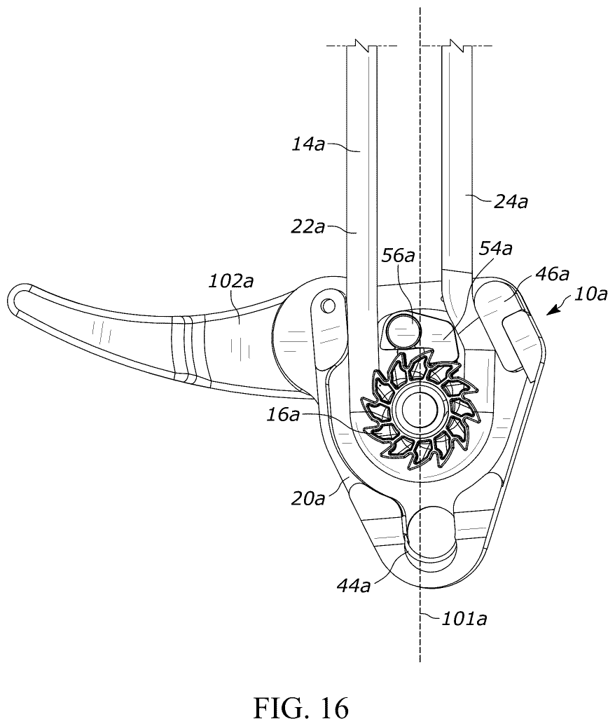

Referring now to FIG. 16, the rope actuating device 10a is shown in an hoisting position (centerline 101a of the chassis 20a generally coincident with a straight vertical axis 126a), with the rope 14a reaved around the sheave 16a in the central groove 80a and passing between the first rope engagement surface 48a of the fixed brake 46a and the second rope engagement surface 62a of the pawl 54a, but unclamped by the first and second rope engaging surfaces 48a, 62a to allow the rope to generally pass therebetween allowing a user to pull the second rope portion 24a upwards to easily hoist a load coupled to the load attachment portion 44a. When not hoisting, a user may wish to clamp the rope 14a to prevent vertical decent of the load (along with the rope actuating device 10a).

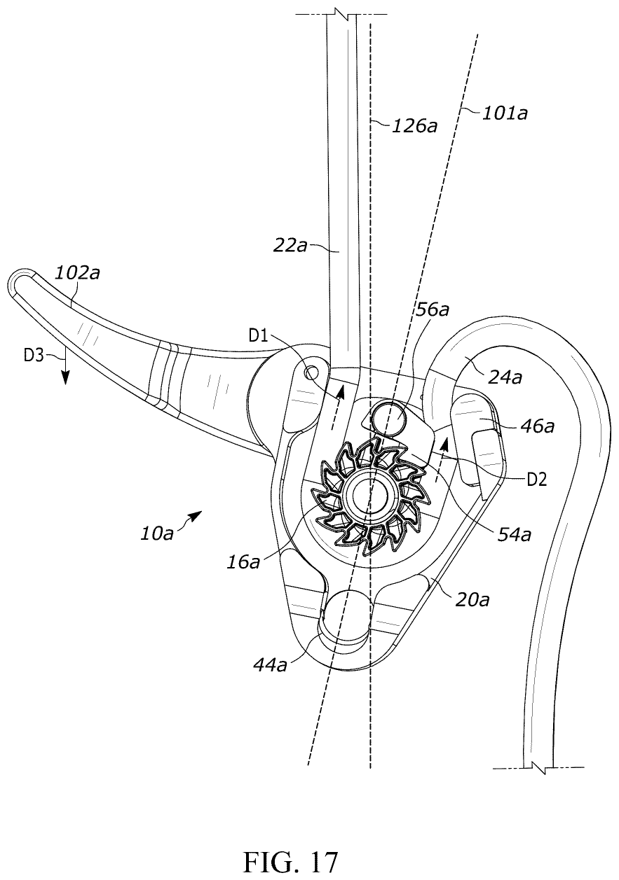

In operation, the rope actuating device 10a becomes clamped (see FIG. 17) when a first rope portion 22a is fixed to an object above the rope actuating device 10a and a load is coupled to the load attachment portion 44a, creating an opposing force on the chassis 20a. The frictional relationship between the rope 14a and the central groove 80a of the sheave 16a urges the sheave to rotate clockwise in the first rotational direction 92a, but the engagement of the teeth 86a with the pawl catch 60a prevents such rotation, which forces the coupled pawl 54a towards the fixed brake 46a, thereby clamping the rope 14a between the first rope engagement surface 48a of the fixed brake 46a and the second rope engagement surface 62a of the pawl 54a, with the opposing force of the load maintaining this rope impingement. In this clamped position, as seen in FIG. 17, the load coupled to the rope actuating device 10a is vertically supported in a static position.

Generally, the rope actuating device 10a is used to hoist or lower a coupled load or to maintain a desired vertical position of a coupled person when ascending or descending (e.g., rescue personnel scaling a cliff, etc.). As such, the rope actuating device 10a is configured to allow for both release of the rope 14a to allow for decent (lowering of a load by passing the rope 14a out in a first direction D1) (e.g., rope outflow), as well as ascent (reeving of the rope 14a through the rope actuating device 10a in a second direction D2 (e.g., rope inflow). As discussed, when a load is attached, the rope actuating device 10a clamps the rope 14a to prevent the device from descending. In this state, for ascent of the device (relative to the rope), a user can pull the second rope portion 24a upwards to feed the rope 14a through the rope actuating device 10a, the force from the second rope portion 24a being pulled imparts a counter-clockwise rotational force on the sheave 16a in the second rotational direction 94a (see FIGS. 4 and 12 for directional arrows, this is the same for all embodiments herein). As the sheave 16a is allowed to rotate counter-clockwise because the teeth 86a ride over the pawl catch 60a) rather than engaging it, the clamping force on the rope 14a is relieved as the pawl is no longer being forcibly pushed towards the fixed brake 46a. In this manner, a user can pull the rope 14a as desired to ascend the rope actuating device 10a, each time the rope 14a is then released, the rope actuating device 10a reverts to clamping the rope 14a again to prevent descent.

For a descent action, the lever assembly 32a is utilized. More particularly, rotating the release handle 102a downward in direction D3 (FIG. 17), causes the bar link 108a to pull the pawl hinge rod 56a along the release slot 38a to move the pawl 54a and its second rope engagement surface 62a in a direction away from the fixed brake 46a to release the clamping of the rope 14a and allow outflow of the rope 14a from the device. As the downward pressure on the handle dictates the level of release, a user can easily regulate the clamping force on the rope 14a to control release of the rope through the rope actuating device 10a and therefore the rate of descent.

As noted above, the rope actuating device can take many forms. Included herein are at least three different exemplary embodiments of the rope actuating device (i.e. rope actuating device 10a, rope actuating device 10b, and rope actuating device 10c), as well as some exemplary embodiments of some of the components that can be used in one or more of the rope actuating devices. For convenience, and to avoid repeating full descriptions of each component and their function, when not required for a person skilled in the art to understand the embodiments the component names have been repeated among the embodiments with their reference numbers appended by a letter (e.g., chassis 20a, chassis 20b, chassis 20c, etc.) to associate the reference number with the respective embodiment. In at least some embodiments, components with the same component name herein can have similar form or function, while in some other embodiments, components with the same component name herein can be identical in form and/or function.

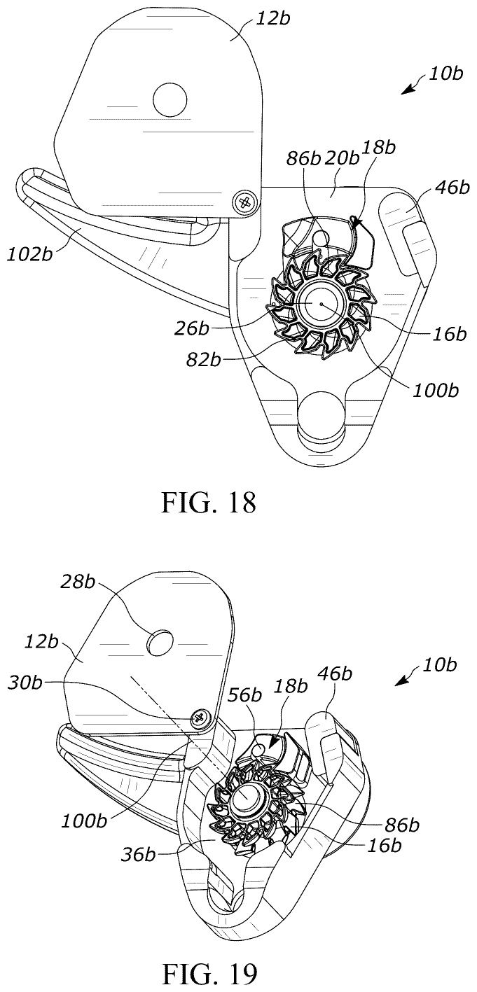

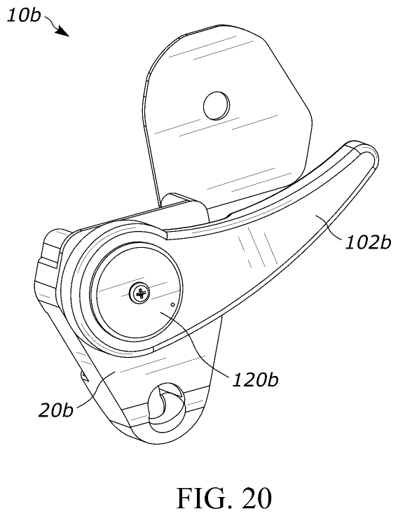

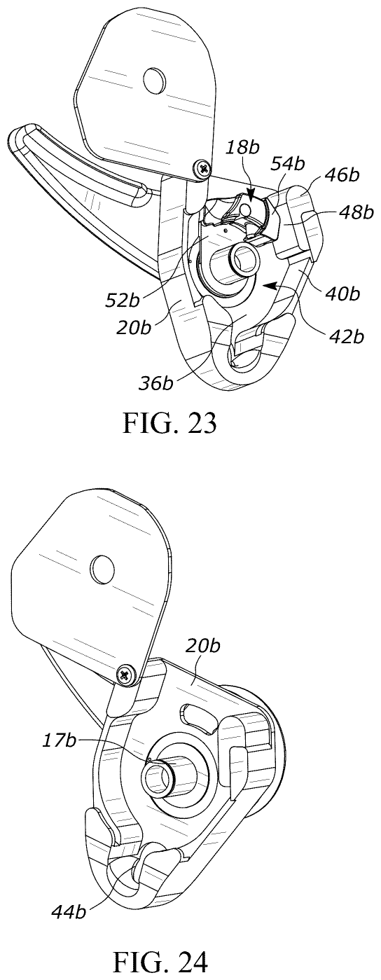

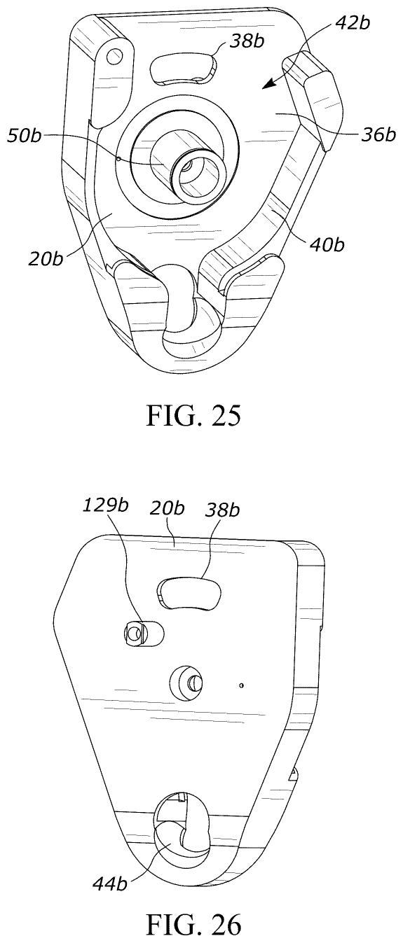

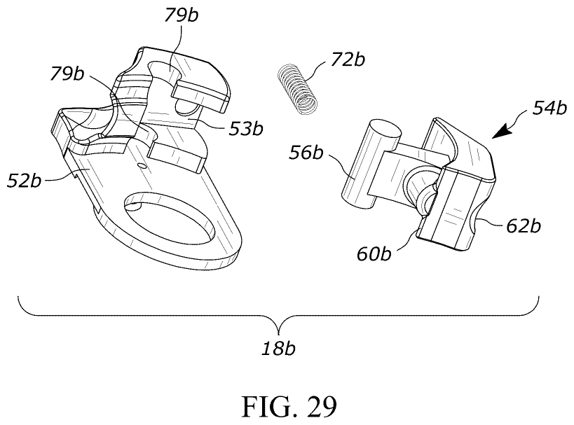

Referring now to FIGS. 18-31 a second exemplary embodiment of a rope actuating device 10b is illustrated. The rope actuating device 10b provides similar resultant functionality to the rope actuating device 10a, but varies with regard to some of the structural configurations.

FIGS. 18-26 illustrate various views of the rope actuating device 10b in various states of assembly and completeness. As shown, the rope actuating device 10b includes a chassis 20b having a rear wall 36b, where in at least some embodiments, the rear wall 36b is generally planar. A sidewall portion 40b extends substantially perpendicularly from the rear wall 36b and along with a chassis cover plate 12b, forms an inner cavity 42b. In at least some embodiments, the sidewall portion 40b is generally U-shaped or V-shaped, although other configurations can be utilized to house a rope. The chassis 20b is coupled with a rotatable sheave 16b (via a sheave sleeve 17b that is inserted into the sheave 16b, along with a sheave washer 19b). The rope actuating device 10b further includes, a pawl assembly 18b, and a lever assembly 32b. While the chassis 20b and sheave 16b are notably similar or identical to earlier embodiments, the pawl assembly 18b and a lever assembly 32b have various notable modifications. A chassis cover plate 12b is coupled to the chassis 20b by a fastener 30b and includes a cover aperture 28b. A chassis cover fastener 26b is also provided to reliably engage with the cover aperture 28b, wherein in at least some embodiments, the chassis cover fastener 26b can include an actuator, spring, washer, etc. The rope actuating device 10b includes a load attachment portion 44b, which in at least some embodiments, is positioned about the bottom of the chassis 20b, and can include an aperture that extends through a rear wall 36b of the chassis 20b.

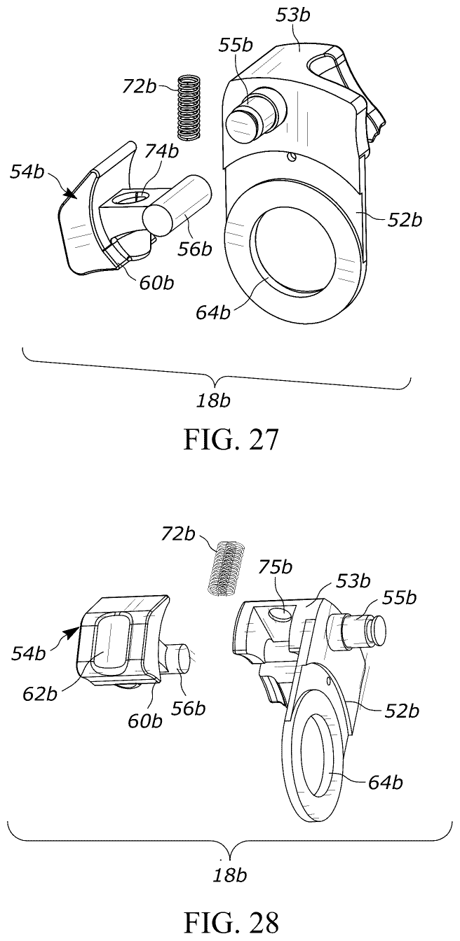

Referencing FIGS. 27-29 illustrating various exploded views of the pawl assembly 18b, it can be seen that the swing arm 52b is at least partially plate shaped and includes a circular pate aperture 64b sized to be rotatably coupled to a generally cylindrical sheave support 50b. The circular aperture 64b includes a central swing arm rotational axis 158b therethrough about which the swing arm 52b rotates relative to the chassis 20b. The pawl 54b is formed integrally with the pawl hinge rod 56b, and the swing arm 52b includes an integrally formed pawl support 53b on a first side and a lever engagement post 55b extending perpendicularly on the opposite side. The lever engagement post 55b is coupled to the lever assembly 32b as discussed below, while the pawl support 53b includes a pair of spaced hinge apertures 79b that are sized and shaped to rotatably couple the pawl hinge rod 56b, thereby providing a hinged connection between the pawl 54b and the pawl support 53b. A pawl spring 72b can be inserted into a spring passage 74b in the pawl 54b and abutted with a spring stop 75b on the ceiling of the pawl support 53b. The pawl spring 72b and hinged connection thereby providing a consistent downward bias of the pawl 54b towards the sheave 16b. The pawl 54b includes a second rope engagement surface 62b and a pawl catch 60b for engagement with teeth 86b extending along first and second sidewalls 82b, 84b of the sheave 16b, although in other embodiments, the teeth 86b can be provided on only one of the first sidewall 82b and second sidewall 84b. Similar to the aforementioned embodiment, the pawl assembly 18b is generally biased clockwise by a bias spring 122b in order to grip the rope 14b. When the pawl catch 60b is engaged with the teeth 86b, such as seen in FIGS. 18, 19, 31 to prevent clockwise rotation, and the rope 14b is wrapped around the sheave 16b and between the first and second rope engaging surfaces 48b, 62b, the rope actuating device 10b applies a clamping force on the rope to secure an attached load in place until either the release handle 102b is actuated as discussed below, or a user pulls the second rope portion 24b upward causing the sheave 16b to rotate counter-clockwise about a sheave central axis 100b (see FIGS. 18 and 19). As such, this embodiment provides similar rope securement and release capabilities that allow a user to both support a load and to hoist a load easily.

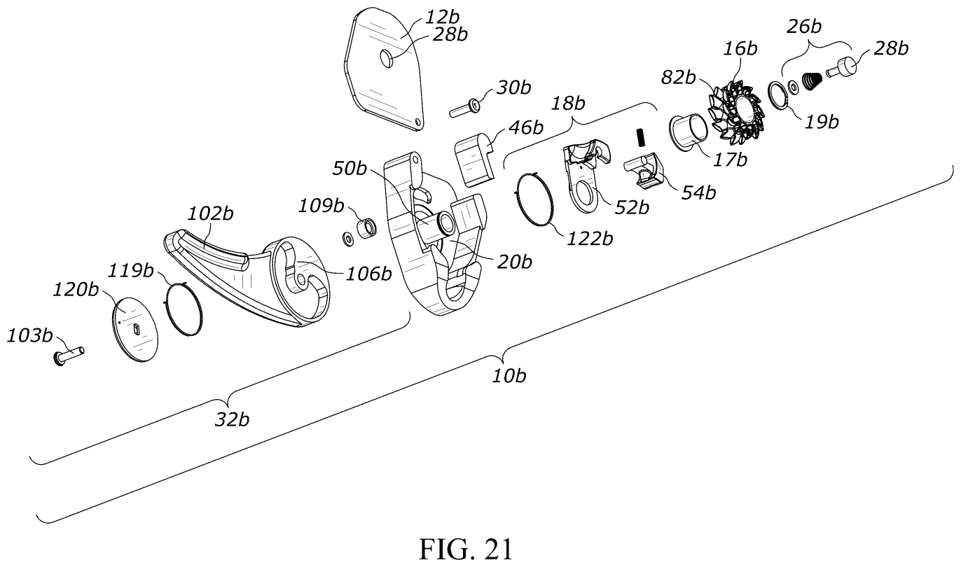

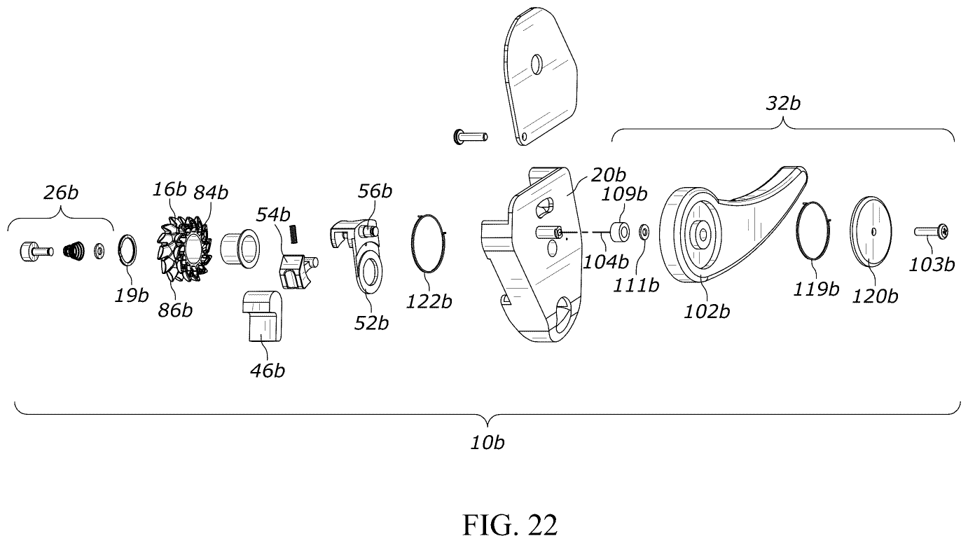

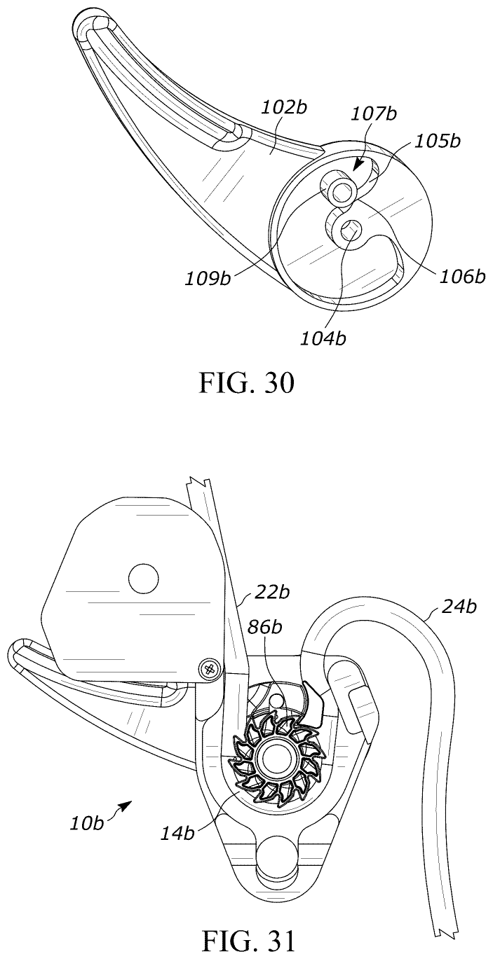

With reference to FIGS. 21 and 22, the lever assembly 32b is configured to perform the similar function of moving the pawl assembly 18b counter-clockwise to displace the second rope engagement surface 62b further away from the first rope engagement surface 48b on the fixed brake 46b sufficiently to allow rope 14b to be released and pass through the rope actuating device 10b. As above, this can be accomplished using various coupling mechanisms that allow a user to push down on a lever to release the tension. As shown in the figures (e.g. FIG. 30), in at least some embodiments the lever assembly 32b includes a release handle 102b that is coupled to the chassis 20b to allow rotation about a handle pivot axis 104b extending through a handle post 129b. The release handle 102b includes a rolling surface 105b extending along an engagement portion 106b formed in a handle cavity 107b in the release handle 102b. The lever engagement post 55b passes through the release slot 38b in the rear wall 36b of the chassis 20b and into the handle cavity 107b where it receives a cylindrical roller 109b thereover (which can be held in place by a washer 111b for example), which in turn rests on the rolling surface 105b. When the release handle 102b is pushed downward (rotated counter-clockwise), the rolling surface 105b pushes against the roller 109b and moves the coupled pawl assembly (via the lever engagement post) counter-clockwise to release tension on the rope 14b. The lever assembly 32b can further include a lever spring 119b coupled to bias the release handle 102b in a desired position and a handle cover plate 120b and handle fastener 103b to secure the lever spring 119b in place.

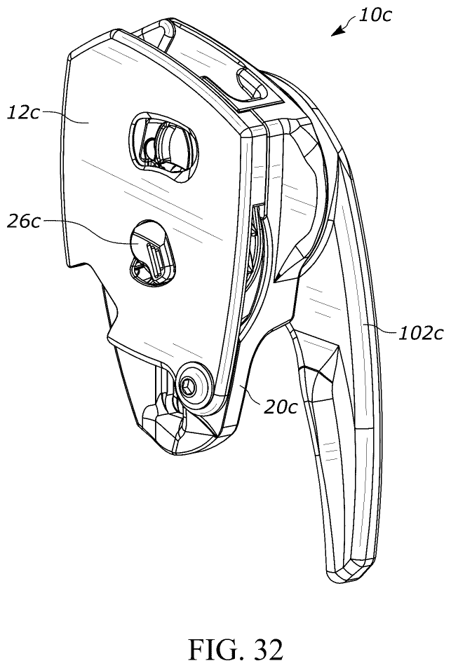

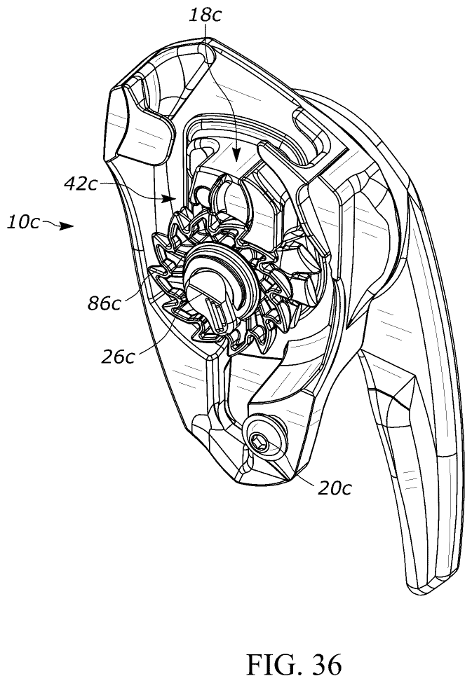

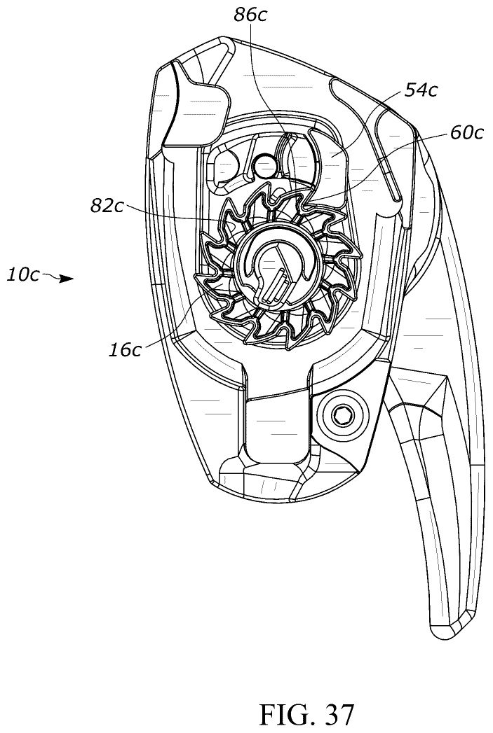

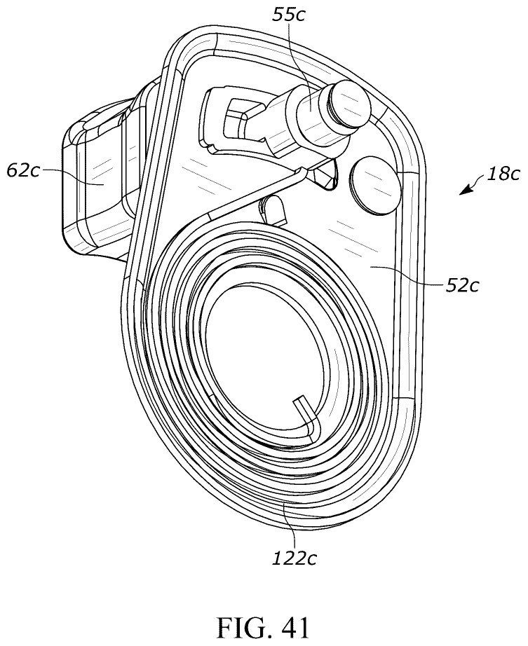

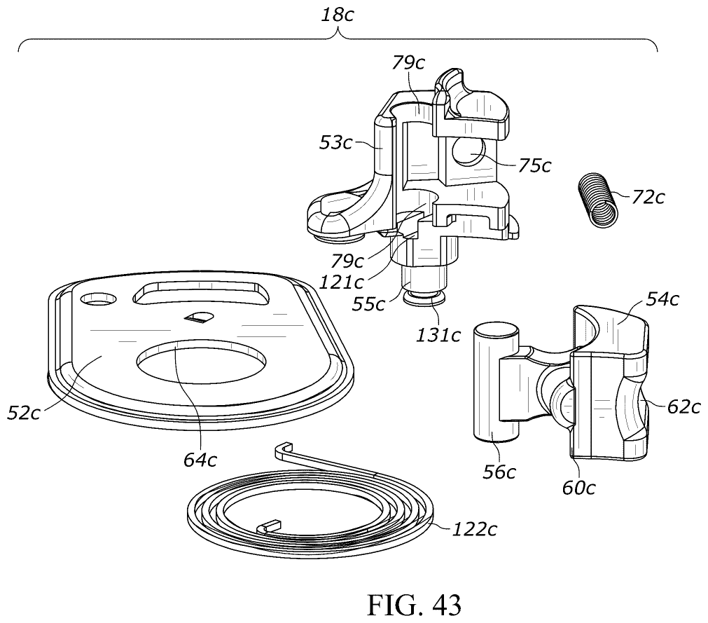

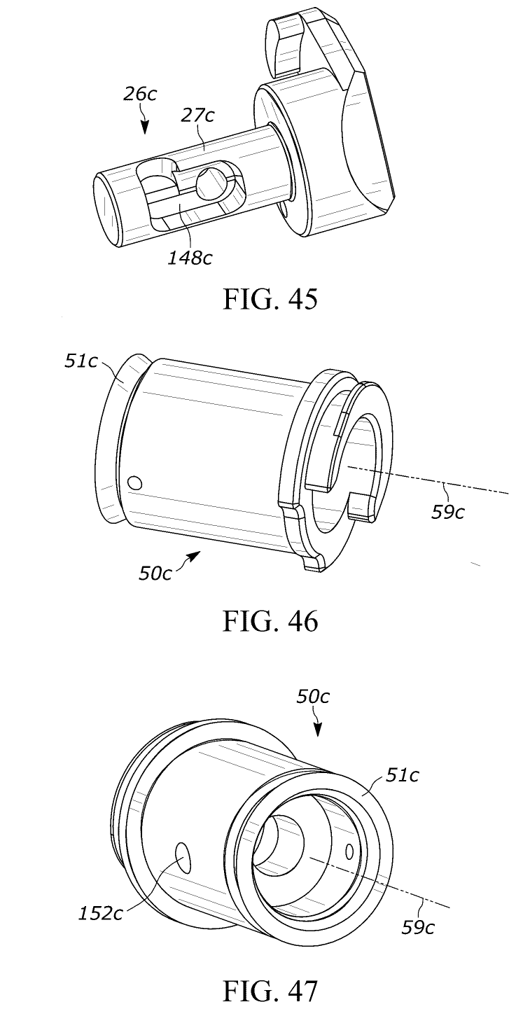

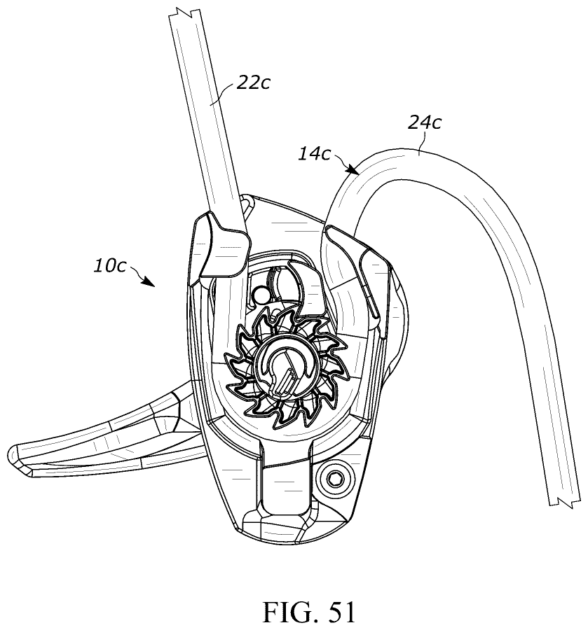

Referring now to FIGS. 32-51, a third exemplary embodiment of a rope actuating device 10c is illustrated. FIGS. 32-51 illustrate various view of the rope actuating device 10c in whole or in part in various states of assembly and completeness. As shown, the rope actuating device 10c includes a chassis 20c coupled with a rotatable sheave 16c, a pawl assembly 18c, and a lever assembly 32c.

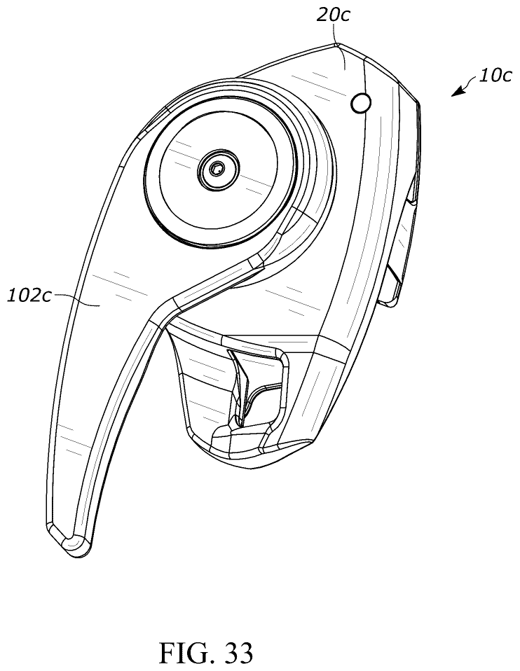

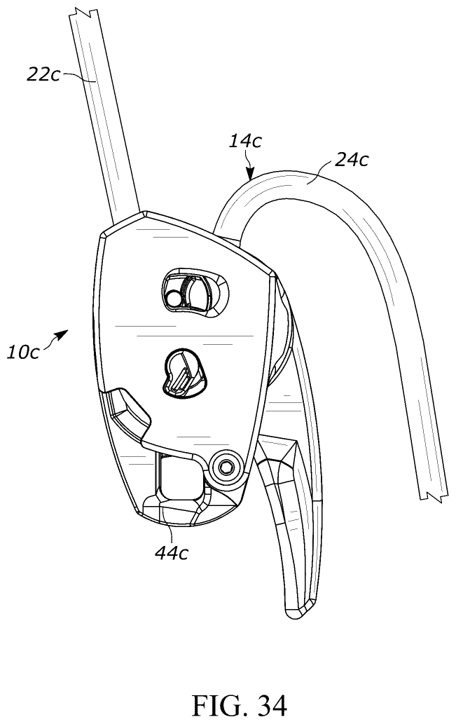

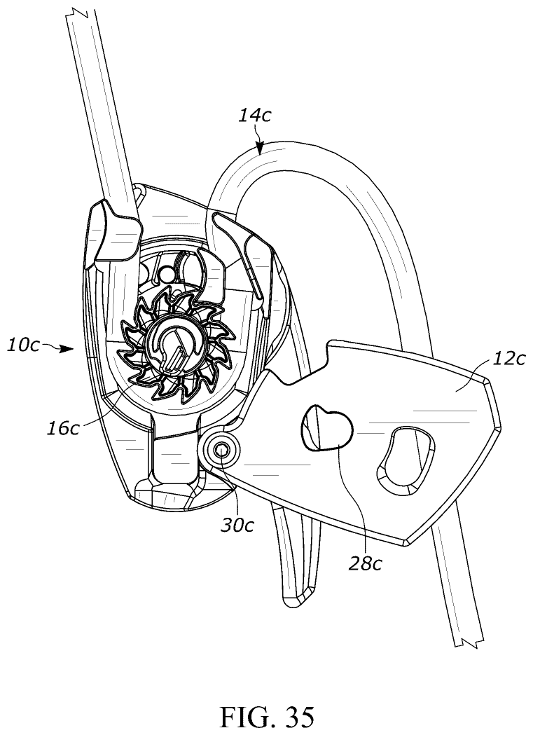

FIGS. 32 and 33 illustrate perspective views of the rope actuating device 10c. The chassis 20c has a rear wall 36c, where in at least some embodiments, the rear wall 36c is generally planar. A sidewall portion 40c extends from the rear wall 36c (e.g., extends perpendicularly) and along with a chassis cover plate 12c, forms an inner cavity 42c. In at least some embodiments, the sidewall portion 40c is generally U-shaped or V-shaped as viewed from the front, although other configurations can be utilized to house a rope. FIG. 34 illustrates the rope actuating device 10c with a rope 14c situated partially in the inner cavity 42c and clamped in place using the pawl assembly 18c. FIG. 35 provides a view with a chassis cover plate 12c rotated open, with a fastener 30c rotatably securing the chassis cover plate 12c to the chassis 20c. A chassis cover fastener 26c is provided that is situated partially inside a cover aperture 28c and can be rotated to engage a portion of the chassis cover plate 12c to secure the chassis cover plate in a closed position. The chassis cover fastener 26c may engage with a biasing spring to urge the chassis cover fastener 26c outward and counter-clockwise. The chassis cover fastener 26c includes a cylindrical portion 27c with a pin engagement cavity 148c (see FIG. 45) configured to engage with a cylindrical pin 150c. The pin 150c is situated partially within a pin aperture 152c in a generally cylindrical sheave support 50c. This engagement allows the sequential rotation and depression of the chassis cover fastener 26c to selectively disengage the chassis cover fastener 26c from the cover aperture 28c, thereby allowing rotation and opening of the chassis cover plate 12c. Similar to the other embodiments, the chassis 20c includes a fixed brake 46c, which can either removable or integrated. In addition, a rope guide 47c can be provided for guiding rope in and out of the rope actuating device 10c. The fixed brake 46c includes a first rope engagement surface 48c, which in at least some embodiment is planar, while other embodiments can vary while providing a surface to engage the rope, such as grooved, etc. In at least some embodiments, the chassis 20c includes a support aperture 49c passing through a rear wall 36c of the chassis 20c. The support aperture 49c has a central support axis 45c that passes therethrough perpendicular to the rear wall 36c.

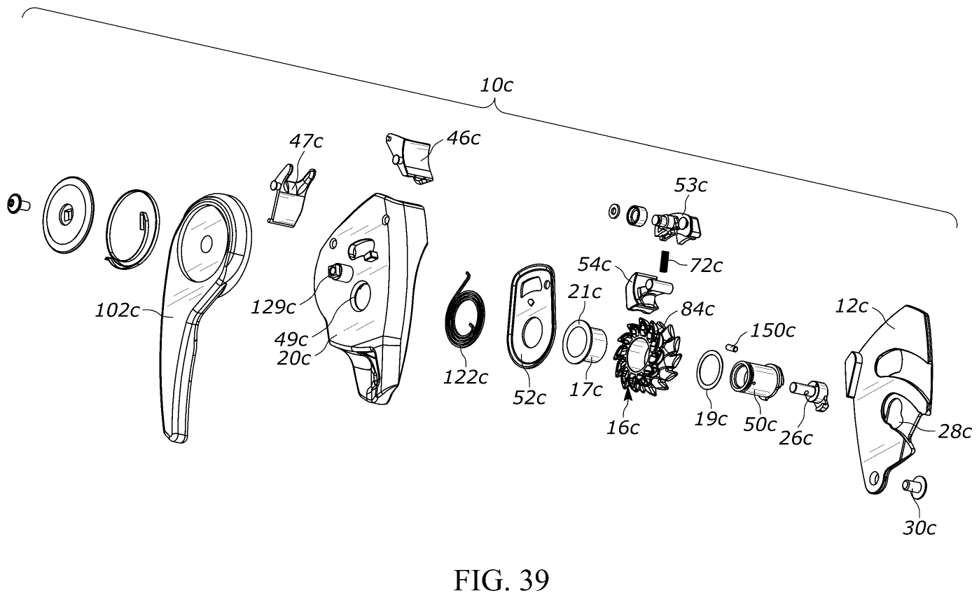

The sheave 16c provides a rotatable support for feeding the rope 14c through the rope actuating device 10c, wherein the sheave 16c can be rotatably coupled to the chassis 20c in various ways, and rotates about a sheave central axis 100c (see FIG. 39), which is coincident with the central support axis 45c. In at least some embodiments, to facilitate rotational coupling, a generally cylindrical sheave sleeve 17c is pressed into the sheave 16c, though in some embodiments, the sheave sleeve can be omitted. In at least some embodiments, the sheave 16c can include a bearing assembly to facilitate enhanced rotation. The sheave sleeve 17c in at least some embodiments is generally cylindrical with a rear flange 21c. The sheave support 50c has a sheave support central axis 59c and is configured to rotationally support the sheave 16c relative to the chassis 20c, as such the sheave support central axis 59c is coincident with the sheave central axis 100c. In embodiments where the sheave sleeve 17c is utilized, the sheave support 50c is sized to receive the sheave sleeve 17c and a sheave washer 19c thereover. The support aperture 49c in the chassis 20c is configured to receive and support the sheave support 50c, although in at least some embodiments, such as seen in the prior embodiments the sheave support 50c can be integrally formed with or secured to the chassis rear wall 36c using other methods such as a fastener that passes through the rear wall 36c and into a threaded passage in the sheave support 50c. As shown, in at least some embodiments, the sheave support 50c can include a flared end 51c that is passed through the support aperture 49c and then pressed to expansion to secure the sheave support 50c to the chassis 20c, although other securement methods can be utilized.

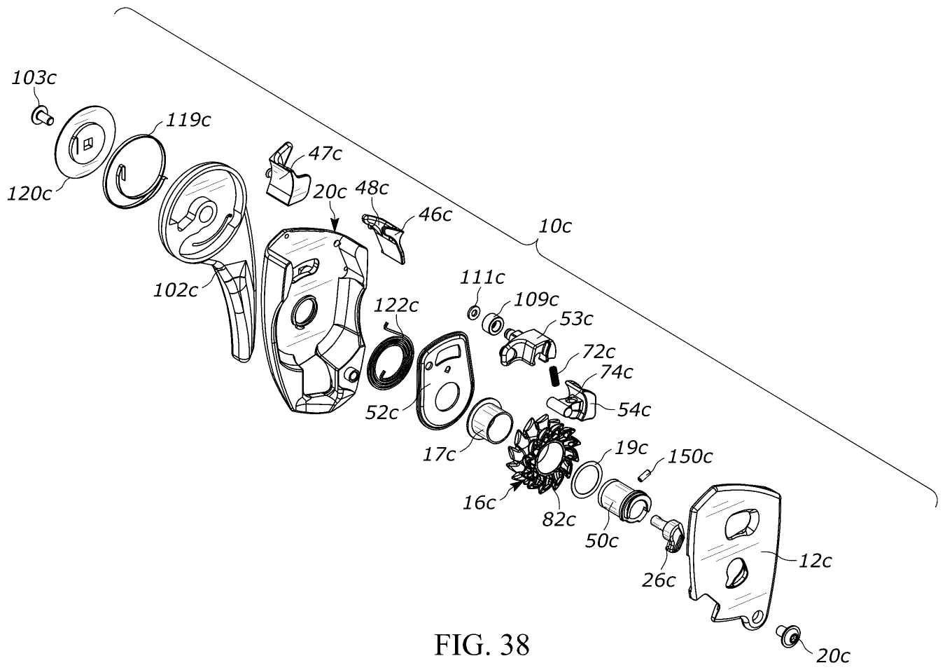

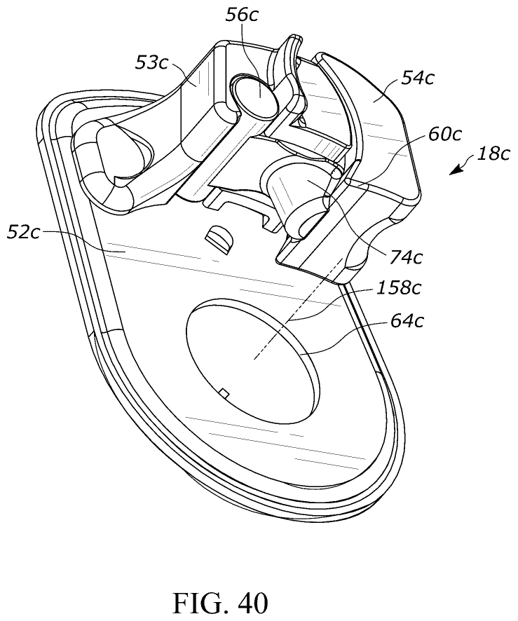

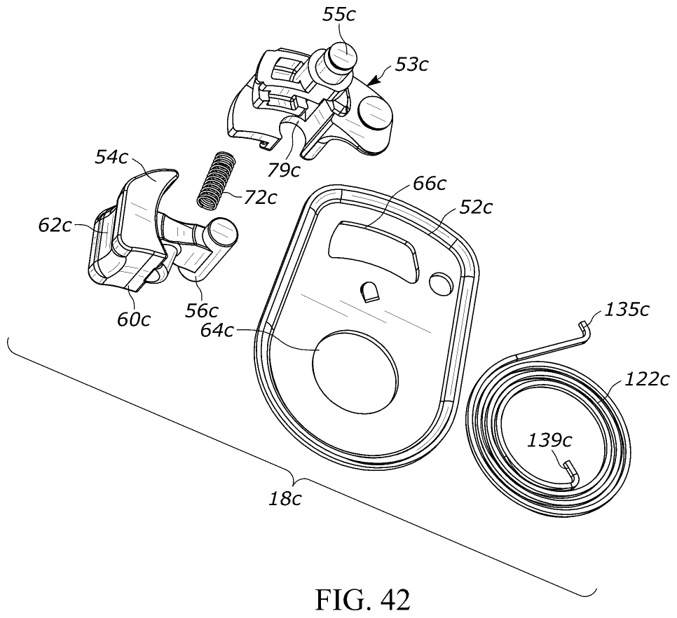

FIGS. 38 and 39 provide perspective exploded views showing an arrangement of the rope actuating device 10c components. FIGS. 40-44 illustrate various views of the pawl assembly 18c, which functions similar to pawl assembly 18b. The pawl assembly 18c in at least some embodiments, includes a pawl 54c, a swing arm 52c, a pawl support 53c, and a bias spring 122c. As shown, the swing arm 52c can be at least partially plate shaped and includes a circular aperture 64c sized to allow the sheave support 50c to pass therethrough. The swing arm 52c also includes a plate slot 66c (see FIG. 42) situated above the circular aperture 64c. The circular aperture 64c includes a central swing arm rotational axis 158c that passes therethrough, about which the swing arm 52c rotates relative to the chassis 20c. The central swing arm rotational axis 158c, sheave central axis 100c, sheave support central axis 59c, and central support axis 45c are coincident. In at least some embodiments, the pawl 54c is formed integrally with a pawl hinge rod 56c, and the pawl support 53c is secured to the swing arm 52c. A lever engagement post 55c extends outward on the pawl support 53c and passes through the plate slot 66c.

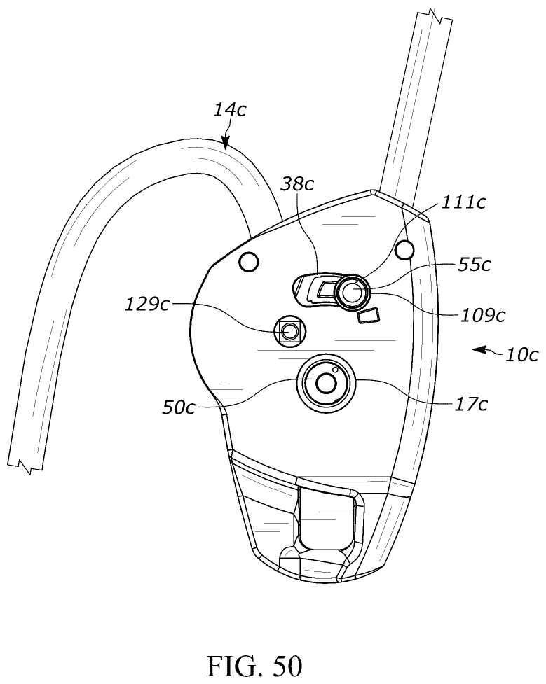

As best seen in FIG. 50, the lever engagement post 55c further extends through a release slot 38c formed in the rear wall 36c of the chassis 20c and is coupled to the lever assembly 32c, as discussed below. The pawl support 53c is hingedly coupled to the pawl 54c and in at least some embodiments, includes a pair of spaced hinge apertures 79c that are sized and shaped to rotatably couple the pawl hinge rod 56c, thereby providing a hinged connection between the pawl 54c and the pawl support 53c, although other methods of hinging can be utilized. This hinged coupling allows the pawl 54c to extend downward independent of the pawl support 53c. In at least some embodiments, a downward bias of the pawl 54c is desired, which can be accomplished in various ways. As shown, a pawl spring 72c can be inserted into a spring passage 74c in the pawl 54c and abutted with a spring stop 75c on the ceiling of the pawl support 53c. The pawl spring 72c and hinged connection thereby providing a consistent downward bias of the pawl 54c towards the sheave 16c for engagement therewith.

The pawl 54c includes a second rope engagement surface 62c and a pawl catch 60c for engagement with teeth 86c extending along first and second sidewalls 82c, 84c of the sheave 16c (sheave 16c is the same as sheave 16a and 16b, see also FIGS. 10-12), although in other embodiments, the teeth 86c can be provided on only one of the first sidewall 82c and second sidewall 84c. Similar to the aforementioned embodiment 10b, the pawl assembly 18c and swing arm 52c are generally biased in a clockwise direction (see FIG. 4, 92a) by the bias spring 122c for the second rope engagement surface 62c to engage the rope 14c. In at least some embodiments, the bias spring 122c is engaged with a notch 121c in the pawl support 53c at a first spring end 135c, and a second spring end 139c is engaged to the front of the chassis 20c, such as via a spring slot 137c, although in some other embodiments, other spring anchor positions can be utilized to provide the desired rotational spring bias. As biased, with the pawl catch 60c engaged with the teeth 86c (such as seen in FIGS. 35-37), clockwise rotation of the sheave 16c (see FIG. 12) is prevented, and as the rope 14c is wrapped around the sheave 16c and between the first and second rope engaging surfaces 48c, 62c, the rope actuating device 10c applies a clamping force on the rope to secure an attached load (user or object coupled to a load attachment portion 44c of the chassis 20c) in place (a first rope portion 22c is under tension to support the load) until either a release handle 102c is actuated as discussed below, or a user pulls a second rope portion 24c upward to pass out from the inner cavity 42c, causing the sheave 16c to rotate counter-clockwise. As such, this embodiment provides similar rope securement and release capabilities as the other embodiments that allow a user to both support a load and to hoist a load easily.

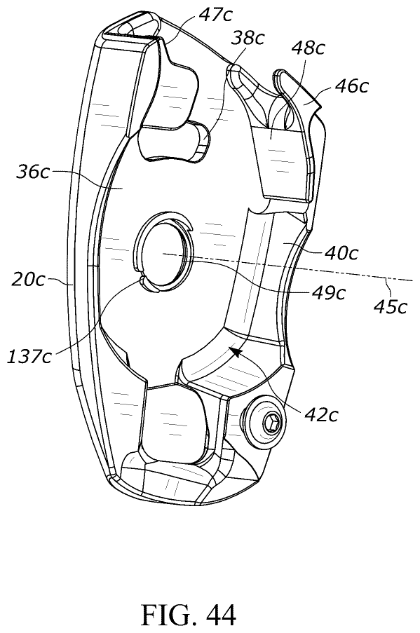

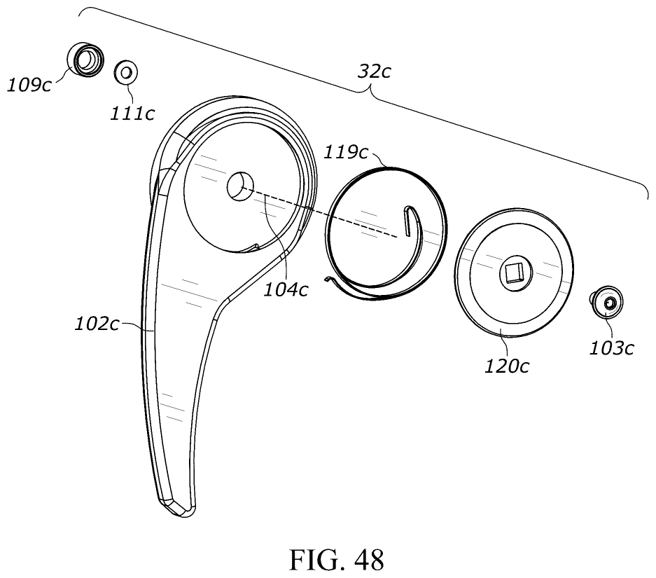

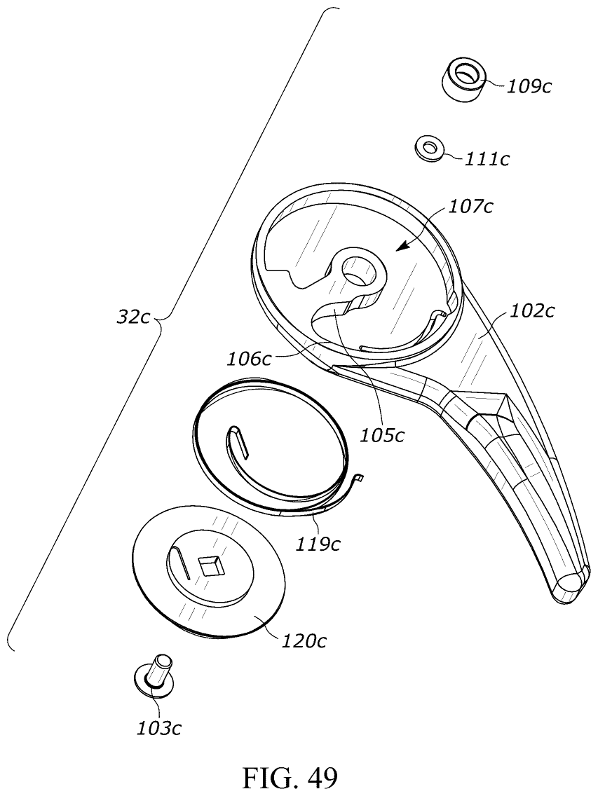

FIGS. 48, and 49 illustrate exploded views of the lever assembly 32c. The lever assembly 32c is configured to perform the similar function of moving the pawl assembly 18c and swing arm 52c counter-clockwise to displace the second rope engagement surface 62c further away from the first rope engagement surface 48c to release tension on the rope 14c and allow the rope 14c to be released and pass through the rope actuating device 10c. As above, this can be accomplished using various coupling mechanisms that allow a user to push down on a handle to release the tension. As shown in the figures, in at least some embodiments the lever assembly 32c includes the release handle 102c that is coupled to the chassis 20c to allow rotation about a handle pivot axis 104c (that extends through a handle post 129c on the chassis 20c). The release handle 102c includes a rolling surface 105c extending along an engagement portion 106c formed in a handle cavity 107c of the release handle 102c, the rolling surface 105 is contoured to effectuate the desired movement of the lever engagement post 55c and in at least some embodiments can include one or more cammed portions 155c (i.e., lobe). A cylindrical roller 109c is rotatably coupled to the lever engagement post 55c and in at least some embodiments can be held in place by a washer 111c that engages a groove 131c (see FIG. 44) in the lever engagement post 55c. The lever engagement post 55c passes through the release slot 38c in the chassis 20c and into the handle cavity 107c such that the roller 109c is positioned along the engagement portion 106c and inside the handle cavity 107c.

In at least some embodiments, the engagement portion 106c is configured in part to include in part, a generally unimpeded circular path to allow the release handle 102c to be rotated significantly counter-clockwise before causing movement of the pawl assembly 18c via the lever engagement post 55c. After the release handle 102c has been rotated into a pre-engagement position (e.g., approx. 200 degrees rotation) the release handle 102c is pushed downward (further rotated counter-clockwise) against the clockwise bias of the pawl assembly 18c until the roller 109c abuts a raised or cammed portion 155c of the rolling surface 105c that pushes the roller 109c in a counter-clockwise direction to move the coupled pawl assembly 18c (via the engaged lever engagement post 55c) counter-clockwise to release tension on the rope 14c (by moving the second rope engagement surface 62c further from the first rope engagement surface 48c). The lever assembly 32c can further include a lever spring 119c coupled to bias the release handle 102c to a disengaged position, and a handle cover plate 120c secured by a handle fastener 103c.

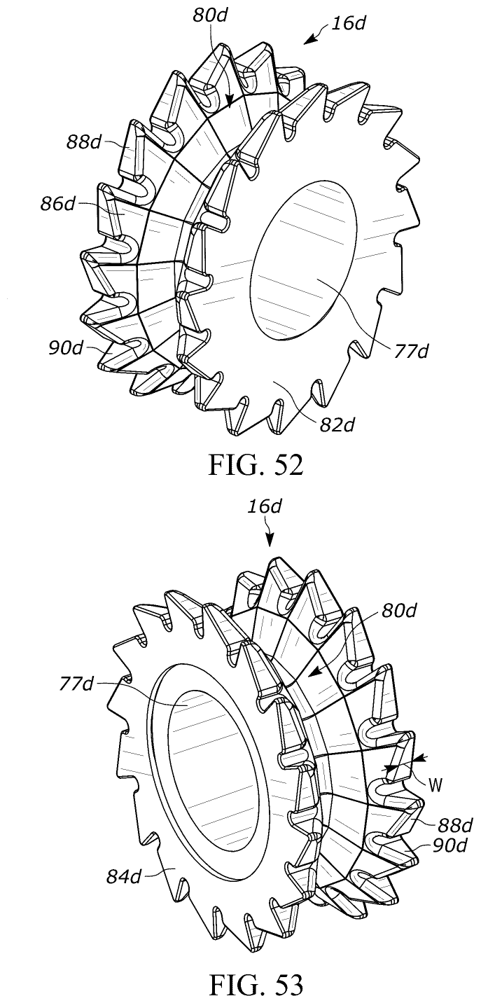

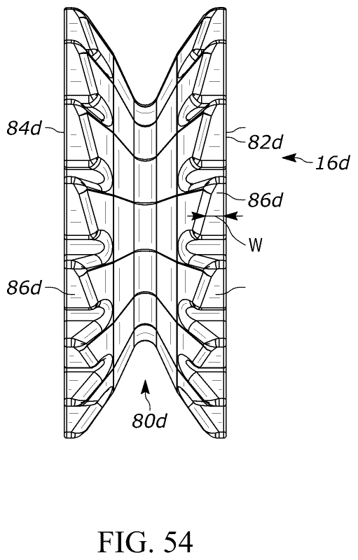

As noted, the sheave can take many forms. A second exemplary embodiment of a sheave 16d is shown in FIGS. 52-54, wherein a first sidewall 82d and second sidewall 84d each include teeth 86d, wherein the teeth 86d have a top edge 88d and a rear edge 90d, and the top edge 88d can have a tapering width W, such that the width W decreases along the top edge 88d as it extends toward the rear edge 90d, although in other embodiments, the teeth 86d can be provided on only one of the first sidewall 82d and second sidewall 84d. The teeth 86d can widen as they extend radially from the top edge 88d towards a central sheave aperture 77d to provide a general V-shape to the central groove 80d extending to the top edge 88d. The sheave 16d is interchangeable with sheave 16a, 16b, and 16c.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of any appended claims and the description of the invention herein. It shall be understood that the phrase “a plurality” can include one or more. The referenced first rotational direction 92a (clockwise) and second rotational direction 94a (counter-clockwise) shown in FIGS. 4 and 12, although not repeatedly shown in other embodiments, shall be considered as applicable to the rotation of all components discussed herein when referencing clockwise or counter-clockwise. Further, the sheaves can vary in thickness and diameter as desired and the teeth thereon can vary in size and quantity as desired.

We claim:

1. A rope actuating device comprising:
a chassis including a chassis rear wall;
a fixed brake coupled with or extending from the chassis, the fixed brake including a first rope engagement surface;
a sheave having a central groove extending between a first sidewall and a second sidewall, wherein at least one of the first sidewall and the second sidewall include teeth, wherein the central groove is engageable with a rope, and the sheave is rotatably coupled at least indirectly with the chassis;
a pawl assembly comprising:
a swing arm rotatably coupled with the chassis; and
a pawl at least indirectly coupled with the swing arm, wherein the pawl includes a second rope engagement surface and a pawl catch for engagement with one or more of the teeth; and
a lever assembly rotatably coupled to the chassis and at least indirectly coupled to the swing arm and the pawl assembly, wherein actuation of the lever assembly provides selectable rotational movement of the swing arm and the pawl assembly.

2. The rope actuating device of claim 1, wherein the lever assembly includes a release handle with an engagement portion, wherein the engagement portion is actuatably coupled with the swing arm such that rotation of the release handle about a handle pivot axis in a first direction causes the swing arm and the pawl to rotate away from the fixed brake.

3. The rope actuating device of claim 2, further comprising a pawl support secured to or formed integrally with the swing arm.

4. The rope actuating device of claim 3, wherein the pawl is hingedly coupled with the pawl support via a pawl hinge rod that is one of integrally formed or coupled with the pawl.

5. The rope actuating device of claim 4, further comprising a sheave support having a sheave support central axis and being secured to or formed integrally with the chassis rear wall.

6. The rope actuating device of claim 5, wherein the sheave includes a sheave central axis and is rotatably coupled to the sheave support.

7. The rope actuating device of claim 6, wherein the swing arm includes a circular aperture sized to receive the sheave support therethrough to rotationally couple the sheave with the swing arm, wherein the circular aperture includes a central swing arm rotational axis. The circular aperture includes a central swing arm rotational axis therethrough about which the swing arm rotates relative to the chassis.

8. The rope actuating device of claim 7, wherein the pawl support includes a lever engagement post, and a release slot formed in the rear wall of the chassis, wherein the lever engagement post extends rearward through the release slot and engages with the lever assembly.

9. The rope actuating device of claim 8, wherein the release handle is spring biased and secured to the chassis by a handle fastener to provide rotation of the release handle about the handle pivot axis, and wherein the release handle further includes a handle cavity and a rolling surface extending along the engagement portion within the handle cavity.

10. The rope actuating device of claim 9, further comprising a cylindrical roller positioned inside the handle cavity and in engagement with the rolling surface, wherein the cylindrical roller is coupled around the lever engagement post, such that actuation of the release handle in a counter-clockwise rotational direction causes the lever engagement post to move across the release slot, thereby rotating the pawl assembly in a counter-clockwise direction about the central swing arm rotational axis.

11. The rope actuating device of claim 10, wherein the pawl support includes a pair of spaced hinge apertures formed therein that at least partially receive the pawl hinge rod to provide a hinged engagement between the pawl and the pawl support.

12. The rope actuating device of claim 11, further including a pawl spring coupled to the pawl and the pawl support to provide a downward bias of the pawl catch towards one or more of the teeth.

13. The rope actuating device of claim 12, wherein the engagement portion includes one or more cammed portions.

14. The rope actuating device of claim 12, wherein the teeth collectively form at least a portion of the central groove of the sheave.

15. The rope actuating device of claim 14, wherein each tooth included in the teeth include a convex inner sidewall.

16. The rope actuating device of claim 15, wherein each tooth included in the teeth include a top edge and a rear edge, wherein the top edge has a radial slope and the rear edge is radially straight and engageable with the pawl catch.

17. The rope actuating device of claim 16, wherein the top edge of each tooth included in the teeth tapers in width as it extends towards the rear edge.

18. The rope actuating device of claim 1, wherein the lever assembly includes a release handle with a handle cavity therein, the handle cavity having an engagement portion, wherein the engagement portion is actuatably coupled with the swing arm such that rotation of the release handle about a handle pivot axis in a first direction causes the second engagement surface to move away from the first engagement surface.

19. The rope actuating device of claim 18, further comprising a pawl support secured to the swing arm, wherein the pawl is hingedly coupled with the pawl support via a pawl hinge rod that is integrally formed on the pawl.

20. The rope actuating device of claim 19, further comprising a sheave support having a sheave support central axis and being secured to the chassis rear wall, wherein the sheave is rotatably coupled to the sheave support, and wherein the swing arm includes a circular aperture with a central swing arm rotational axis, the circular aperture is sized to receive the sheave support therethrough to rotationally couple the sheave with the swing arm, wherein the swing arm rotates relative to the chassis about the central swing arm rotational axis.
